(19) United States
(12) Patent Application Publication
(10) Pub. No.: US 2006/0207392 A1
(43) Pub. Date: Sep. 21, 2006

(54) Ratchet wrench direction oriented structure

(76) Inventor: Mei-Hsiang Lai, Taichung City (TW)

Correspondence Address: CHARLES E. BAXLEY, ESQ., 90 JOHN STREET, THIRD FLOOR, NEW YORK, NY, 10038, US

(21) Appl. No.: 11/085,455

(22) Filed: Mar. 21, 2005

(51) Int. Cl. B25B 13/46

(52) U.S. Cl. 81/61; 81/62

(57) ABSTRACT

A ratchet wrench direction oriented structure includes a wrench body having a driver housing at its tip, an accommodating groove in the driver housing, a ratchet axially disposed in the accommodating groove, a workpiece hole in the middle of the ratchet, a plurality of ratchet teeth around the external periphery of the ratchet, a cover for sealing an opening of the driver housing; wherein the accommodating groove has a limit groove on one side, at least one direction oriented gear member with an end axially coupled to the walls of the limit groove and having a plurality of direction oriented teeth extended from the other side, and a spring on a side of the direction oriented gear member and the wall of the limit groove, so that the direction oriented teeth are elastically engaged at the position of the ratchet teeth to produce a limit effect of a one-way rotation.

### BACKGROUND OF THE INVENTION

1. Field of the Invention

The present invention generally relates to a ratchet wrench direction oriented structure, and more particularly relates to a ratchet wrench structure capable of fixing or switching its rotary direction.

2. Description of the Related Art

A traditional ratchet wrench usually comes with a body having a workpiece hole at its tip, and the workpiece hole at its periphery has a plurality of waved latching edges to be secured with a workpiece by a screw. After the latching edges are secured onto the workpiece, the workpiece can be turned. However, when a user holds and rotates such prior art ratchet wrench by a hand, the angle of rotation is limited by the hand, and thus the user has to repeatedly unload the wrench to adjust the angle of rotation and constantly repeat the movements until the workpiece is installed or removed.

### SUMMARY OF THE INVENTION

A primary objective of the present invention is to provide a ratchet wrench direction oriented structure, such that a direction oriented gear is elastically engaged with an eccentric ratchet wrench to produce a one-way idle rotation of the ratchet. Therefore, a user no longer needs to repeatedly unload the wrench to adjust the turning angle of the wrench as to complete the installation or removal of a workpiece.

To achieve the foregoing technical solution, the present invention comprises:

a wrench body, having a driver housing at its tip, an accommodating groove in the driver housing, a ratchet axially coupled in the accommodating groove, a workpiece hole disposed in the middle of the ratchet, a plurality of ratchet teeth disposed around the external periphery of the ratchet, and a cover for sealing an opening of the driver housing; wherein the accommodating groove has a limit groove disposed on one side of the accommodating groove; and

at least one direction oriented gear member, having an end axially coupled to the walls of the limit groove, a plurality of direction oriented teeth extended from the other end, and a spring installed on a lateral side of the direction oriented gear member and the walls of the limit groove, so that the direction oriented teeth are elastically engaged at the position of the ratchet teeth to produce a limit effect of a one-way rotation.

### BRIEF DESCRIPTION OF THE DRAWINGS

FIG. 1 is an exploded view of the present invention;

FIG. 2 is a perspective view of the present invention;

FIG. 3 is a schematic view of the planar movements of a direction oriented structure of the present invention;

FIG. 4 is another schematic view of the planar movements of a direction oriented structure of the present invention;

FIG. 5 is an exploded view of another preferred embodiment of the present invention;

FIG. 6 is a schematic view of another preferred embodiment of the present invention; and

FIG. 7 is a schematic view of the movements of a direction switching protrusion according to another preferred embodiment.

### DETAILED DESCRIPTION OF THE PREFERRED EMBODIMENTS

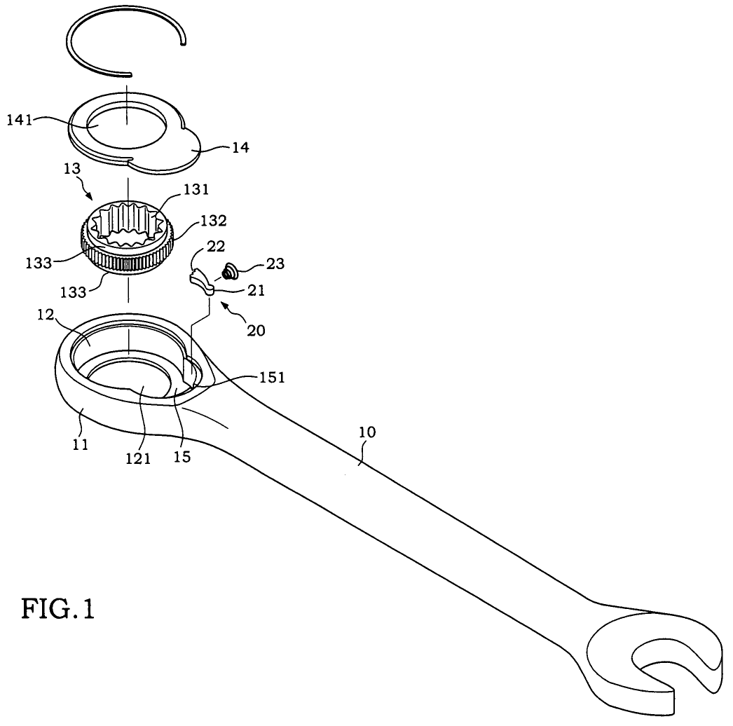

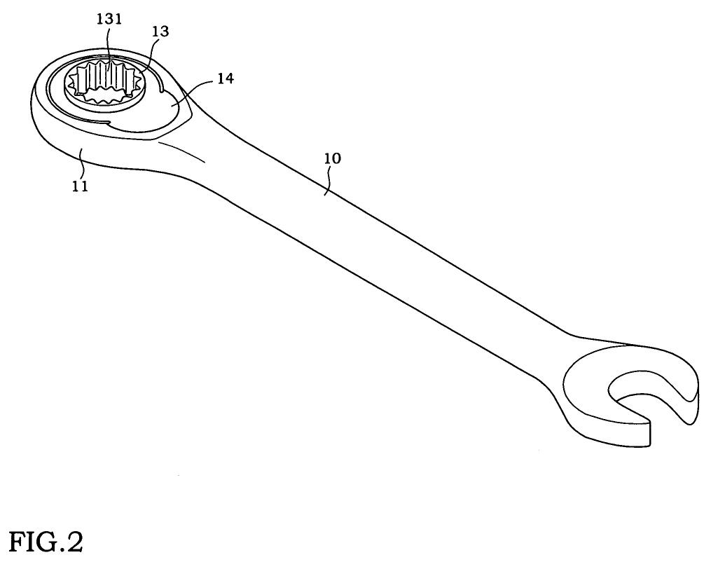

Referring to FIGS. 1 and 2, a ratchet wrench direction oriented structure in accordance with the present invention comprises:

a wrench body 10, having a driver housing 11 at its tip, an accommodating groove 12 in the driver housing 11, a ratchet 13 axially coupled in the accommodating groove 12, a workpiece hole 131 disposed in the middle of the ratchet 13, a plurality of ratchet teeth 132 disposed around the external periphery of the ratchet 13, a hollow axial end 133 extended from both ends of the ratchet 13, a cover 14 for sealing an opening of the driver housing 11, an axial hole 121, 141 disposed at the corresponding positions of the accommodating groove 12 and the cover 14 for axially coupling the axial end 133 of the ratchet 13; wherein the accommodating groove 12 has a limit groove 15 disposed on one side of the accommodating groove 12; and

at least one direction oriented gear member 20 including an axial rotation section 21 at an end, a rotary groove 151 disposed at a corresponding wall of the limit groove 15 for axially coupling the axial rotation section 21, a plurality of direction oriented teeth 22 extended from the other end of the direction oriented gear member 20, and a spring 23 installed on a lateral side of the direction oriented gear member 20 and the wall of the limit groove 15, so that the direction oriented teeth 132 are elastically engaged at the positions of the ratchet 13 and the direction oriented gear member 20 is eccentrically engaged at the ratchet 13 to produce a limit effect for a one-way rotation of the ratchet 13.

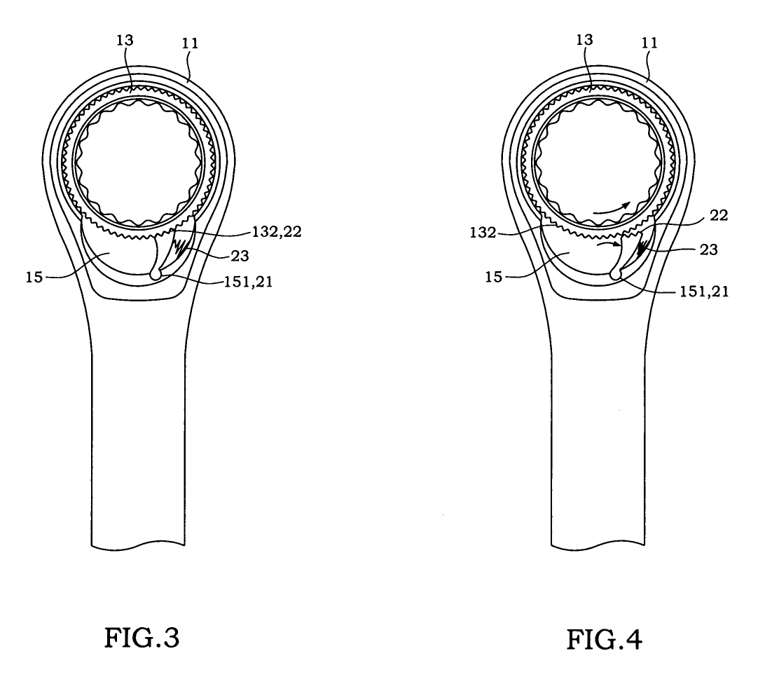

Referring to FIG. 3, the direction oriented gear member 20 will latch the ratchet 13 and stop the rotation of the ratchet 13 by the push of the spring 23, so as to rotate a workpiece in the workpiece hole 131, if the ratchet 13 is rotated clockwise. Referring to FIG. 4, the ratchet 13 will push the direction oriented gear member 20 towards the spring 23 to separate the direction oriented teeth 22 and the ratchet teeth 132, such that the ratchet 13 will produce an idle rotation, if the ratchet 13 is rotated counterclockwise.

With the elastic and eccentric engagement of the direction oriented gear member 20 and the ratchet 13 according to the present invention, the ratchet 13 can produce an idle rotation, so that users need not to repeatedly unload the wrench to adjust the turning angle of the wrench. Users just need to turn over the wrench to fit the workpiece into the workpiece hole 131 to switch the turning direction of the wrench.

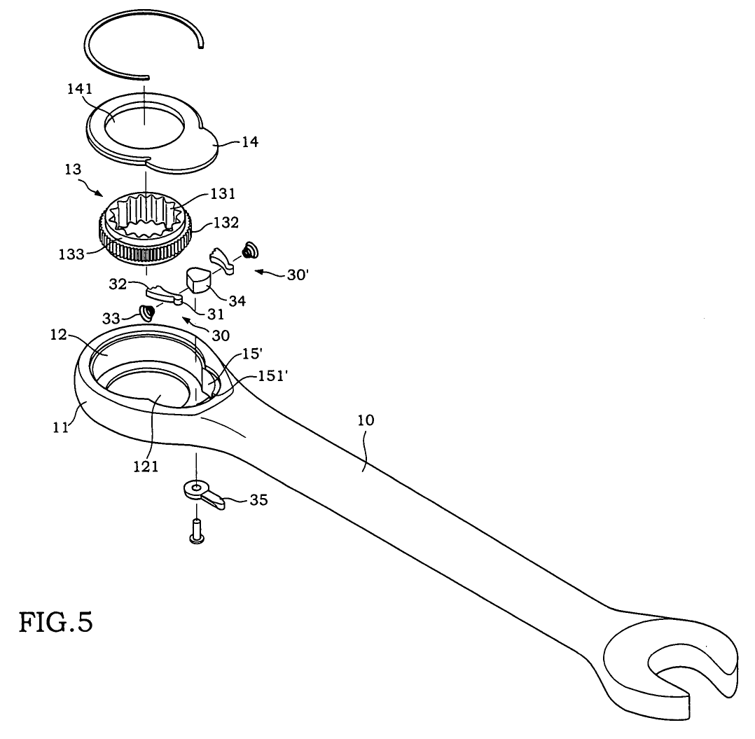

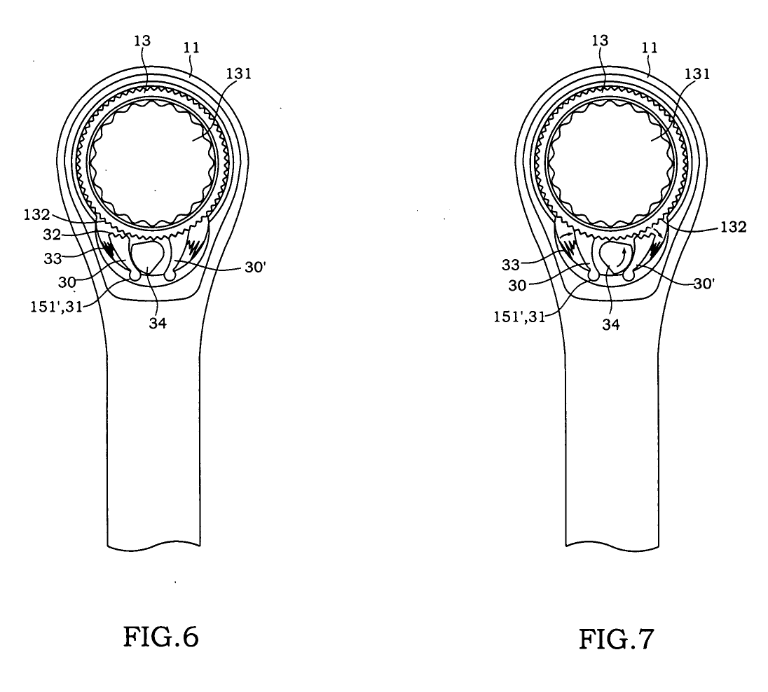

Referring to FIGS. 5 and 6, a second preferred embodiment of the present invention is illustrated, wherein the structure of the wrench body is the same as that described in the first preferred embodiment, and thus will not described here, and the ratchet wrench direction oriented structure of this embodiment comprises:

at least two direction oriented gear members 30, 30′ having an axial rotation section 31 at an end of the direction oriented gear member 30, 30′, and a rotary groove 151′ disposed at a corresponding wall of the limit groove 15′ for axially coupling the axial rotation section 31, a plurality of direction oriented teeth 32 extended from the other end of the direction oriented gear member 30, 30′, and a spring 33 installed on a lateral side of the direction oriented gear member 30, 30′ and the wall of the limit groove 15′, so that the direction oriented teeth 132 are elastically engaged with both sides of the ratchet 13 under normal conditions, wherein a direction switching protrusion 34 is disposed eccentrically between the two direction oriented gear members 30, 30′, and an end of the direction switching protrusion 34 is protruded outside the driver housing 11, and a turn button 35 is provided for users to switch the eccentric rotation of the direction switching protrusion 34.

Since the direction switching protrusion 34 is coupled eccentrically, a side of the direction oriented gear member 30 can be pushed to separate itself from the ratchet 13. Therefore, the direction oriented structure can have a limit effect on the direction oriented gear member 30′ on one side so as to achieve the purpose of limiting the wrench to have one-way rotations. If a user wants to switch to another idle rotation direction, the user just needs to turn the turn button 35 and drive the direction switching protrusion 34 to rotate eccentrically as shown in FIG. 7, so as to push another side of the direction oriented gear member 30 to be separated from the ratchet 13. Therefore, the direction oriented gear member 30 elastically resumes its position and is engaged with the ratchet 13 to change the rotation direction of the direction oriented structure.

The description and its accompanied drawings are used for describing two preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A ratchet wrench direction oriented structure, comprising:
a wrench body, having a driver housing at its tip, an accommodating groove disposed in said driver housing, a ratchet axially coupled in said accommodating groove, a workpiece hole disposed in the middle of said ratchet, a plurality of ratchet teeth disposed around the external periphery of said ratchet, a cover for sealing an opening of said driver housing; wherein said accommodating groove has a limit groove disposed on one side of said accommodating groove; and
at least one direction oriented gear member having an end axially coupled to the wall of said limit groove and a plurality of direction oriented teeth extended from the other end, and a spring installed on a lateral side of said direction oriented gear member and the wall of said limit groove, so that said direction oriented teeth are elastically engaged at the positions of said ratchet teeth to produce a limit effect of a one-way rotation.

2. The ratchet wrench direction oriented structure of claim 1, wherein said ratchet comprises a hollow axial end extended individually from both ends and an axial hole disposed individually from both ends and an axial hole disposed individually at the corresponding positions of said accommodating groove and said cover for movably and axially coupling said axial end of said ratchet.

3. The ratchet wrench direction oriented structure of claim 1, wherein said direction oriented gear member has an axial rotation section at one end, and a rotation groove disposed on the corresponding wall of said limit groove for axially coupling said axial rotation section.

4. The ratchet wrench direction oriented structure of claim 3, wherein said direction oriented gear member is eccentrically engaged with said ratchet.

5. A ratchet wrench direction oriented structure, comprising:
a wrench body, having a driver housing at its tip, an accommodating groove disposed in said driver housing, a ratchet axially coupled in said accommodating groove, a workpiece hole disposed in the middle of said ratchet, a plurality of ratchet teeth disposed around the external periphery of said ratchet, a cover for sealing an opening of said driver housing; wherein said accommodating groove has a limit groove disposed on one side of said accommodating groove; and
at least two direction oriented gear members, and each having an end axially coupled to the walls on both sides of said limit groove and having a plurality of direction oriented teeth extended from the other end, so that said direction oriented teeth are elastically engaged at the positions of said ratchet teeth; wherein a direction switching protrusion is axially disposed between said two direction oriented gear members and rotated to switch the connection or separation of said two direction oriented gear members and said ratchet teeth.

6. The ratchet wrench direction oriented structure of claim 5, wherein said ratchet comprises a hollow axial end extended individually from both ends and an axial hole disposed individually at the corresponding positions of said accommodating groove and said cover fro movably and axially coupling said axial end of said ratchet.

7. The ratchet wrench direction oriented structure of claim 5, wherein said direction oriented gear member has an axial rotation section at one end, and a rotation groove disposed on the corresponding wall of said limit groove for axially coupling said axial rotation section.

8. The ratchet wrench direction oriented structure of claim 7, wherein said direction oriented gear member is eccentrically engaged with said ratchet.

9. The ratchet wrench direction oriented structure of claim 5, wherein said direction switching protrusion is eccentrically and axially coupled.

10. The ratchet wrench direction oriented structure of claim 5, wherein said direction switching protrusion has an end protruded outside said driver housing and a turn button for users to switch an eccentric rotation of said direction switching protrusion.
